(19) United States
(12) Patent Application Publication
(10) Pub. No.: US 2011/0007896 A1
(43) Pub. Date: Jan. 13, 2011

(54) Data Exchange Apparatus and Method

(75) Inventor: Chih-Nong Chen, Dallas, TX (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ARDI TECHNOLOGY CORP., Chung-Ho City, Taipei County (TW)

(21) Appl. No.: 12/499,195

(22) Filed: Jul. 8, 2009

(51) Int. Cl. H04K 1/10; H04B 7/00; G06F 15/16

(52) U.S. Cl. 380/33; 455/68; 709/217

(57) ABSTRACT

Data exchange apparatuses and methods are provided. Two data exchange apparatuses are able to use a plurality of channels. One of the data exchange apparatus plays the active mode, while the other data exchange apparatus plays the passive mode. The active data exchange apparatus selects a first channel and transmits a data exchange request to the passive data exchange apparatus automatically through the first channel. The passive data exchange apparatus transmits an acknowledgment signal to the active data exchange apparatus automatically. Both the active and passive data exchange apparatuses select a second channel according to the acknowledgment signal and then exchange data through the second channel. People who owned a data exchange apparatus of the present invention can easily gather information according to his or her requirement from people who also own a data exchange apparatus.

### CROSS-REFERENCES TO RELATED APPLICATIONS

Not applicable.

### BACKGROUND OF THE INVENTION

1. Field of the Invention

The present invention relates to a data exchange apparatus and method. More specifically, the present invention relates to a data exchange apparatus and method for exchanging the data in a wireless network.

2. Descriptions of the Related Art

Data exchanges among all kinds of devices are very important nowadays. People would like to share the files stored in their own devices with someone else, for example, MP3s, pictures, address book and electrical business cards. Many adaptive protocols were developed based on the demands.

Two familiar data transmission protocols used in electric devices are introduced hereinafter. Infrared Rays (IR) is a very common data transmission protocol being used in the electronic devices with the advantage of low cost. Bluetooth is becoming more and more popular these days, because it has a faster transmission rate and a wider transmission range.

Although IR and Bluetooth are easily to be manipulated, one shortcoming of them is that people have to operate them manually in order to transmit data. Specifically, a user has to decide which people he or she would like to exchange data with. Then, the user needs to send a command to exchange data by the protocols of IR or Bluetooth. In the other words, if the devices are not in use by any user, no data exchange will happen.

Another shortcoming of IR and Bluetooth is the poor transmission property. Regarding to IR, people cannot exchange data conveniently because the requirement of line-of-sight transmission. Hence, the transmissions fail frequently if the devices used the IR protocol for transmitting data. As for Bluetooth, the protocol of Bluetooth may be interfered by the radio waves of other systems due to the radio wave of Bluetooth is restricted as Industrial Scientific Medical (ISM) Band. It means that the radio wave of Bluetooth has a great chance to be interfered if there were some systems using the same ISM band at the same time and within the same communication range.

Consequently, there is an urgent need to develop a robust and convenient apparatus and method for people to exchange data.

### SUMMARY OF THE INVENTION

An objective of this invention is to provide a data exchanging method for use in a wireless apparatus. The wireless apparatus is able to use a plurality of channels. The data exchange method comprises the following steps of: (a) selecting a first channel among the channels; (b) receiving a data exchange request from another wireless apparatus through the first channel automatically; (c) transmitting an acknowledgment signal to the another wireless apparatus through the first channel after receiving the data exchange request; (d) selecting a second channel among the channels according to the acknowledgment signal; (e) transmitting a first data stored in the wireless apparatus to the another wireless apparatus through the second channel; and (f) receiving a second data from the another wireless apparatus through the second channel.

Another objective of this invention is to provide a data exchanging apparatus. The data exchange apparatus is able to use a plurality of channels. The data exchange apparatus comprises a storage unit, a processing unit, and a transceiver. The storage unit is being configured to store a first data. The processing unit is configured to select a first channel among the channels. The transceiver is configured to receive a data exchange request from another data exchange apparatus through the first channel automatically and transmit an acknowledgment signal to the another data exchange apparatus after receiving the data exchange request. The processing unit is further configured to select a second channel among the channels according to the acknowledgement signal. The transceiver is further configured to transmit a first data to the another data exchange apparatus through the second channel and receive a second data from the another data exchange apparatus through the second channel.

Yet a further objective of this invention is to provide a data exchange method for use in a wireless apparatus. The wireless apparatus is able to use a plurality of channels. The data exchange method comprises the following steps of: (a) selecting a first channel among the channels; (b) transmitting a data exchange request to another wireless apparatus through the first channel automatically; (c) receiving an acknowledgement signal from the another wireless apparatus through the first channel after transmitting the data exchange request; (d) selecting a second channel among the channels according to the acknowledgement signal; (e) transmitting a first data to the another wireless apparatus through the second channel; and (f) receiving a second data from the another wireless apparatus through the second channel. Yet a further objective of this invention is to provide a data exchange apparatus. The data exchange apparatus is able to use a plurality of channels. The data exchange apparatus comprises a storage unit, a processing unit, and a transceiver. The storage unit is configured to store a first data. The processing unit is configured to select a first channel among the channels. The transceiver is configured to transmit a data exchange request to another data exchange apparatus through the first channel automatically and receive an acknowledgement signal from the another data exchange apparatus through the first channel after transmitting the data exchange request. The processing unit is further configured to select a second channel among the channels according to the acknowledgement signal. The transceiver is further configured to transmit the first data to another data exchange apparatus through the second channel and receive a second data from the another data exchange apparatus through the second channel. According to the above description, the data exchange methods and the data exchange apparatuses of the present invention can accomplish the data exchange automatically. A data exchange apparatus (i.e. wireless apparatus being able to execute the data exchange method) of the present invention is equipped with the active mode and/or passive mode. A user may operate a data exchange apparatus in the active mode by setting a data exchange criterion in the data exchange request, then the data exchange apparatus can transmit data exchange request automatically to see if another other data exchange apparatus in the neighborhood storing data that meets the data exchange criterion. On the other hand, the user can operate the data exchange apparatus in the passive mode; that is, the data exchange apparatus functions in response to a data exchange request from other data exchange apparatuses.

Consequently, people who owned a data exchange apparatus of the present invention can easily gather information according to his or her requirement from people who also own a data exchange apparatus.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of the first embodiment of the present invention;

FIG. 2 is another schematic view illustrating the first embodiment;

FIG. 3 is a flowchart of the second embodiment of the present invention; and

FIG. 4 is a flowchart of the third embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications, or particular implementations described in these embodiments. Therefore, descriptions of these embodiments are only intended to illustrate rather than to limit the present invention. It should be appreciated that, in the following embodiments and the attached drawings, elements not related directly to the present invention are omitted from illustration; and dimensional relationships among individual elements in the attached drawings are illustrated only for ease of understanding, but not to limit the actual scale.

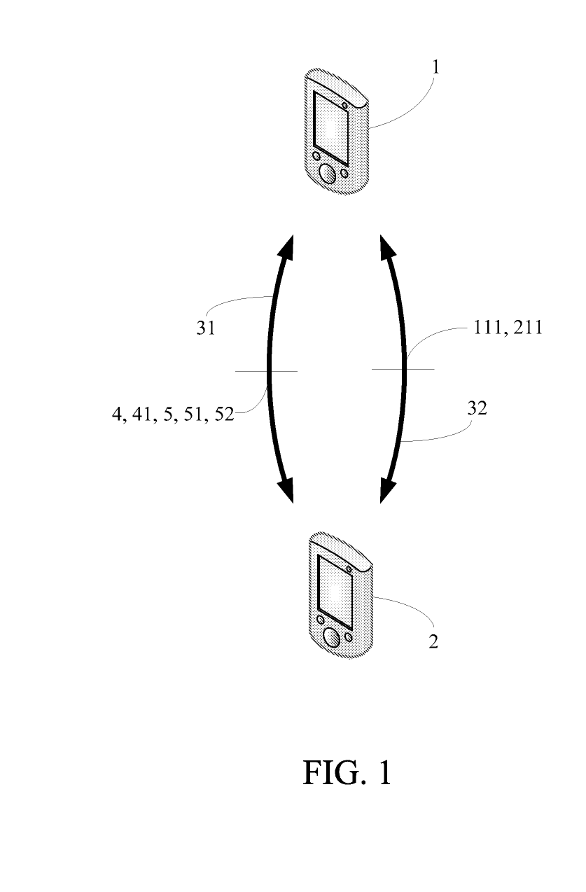

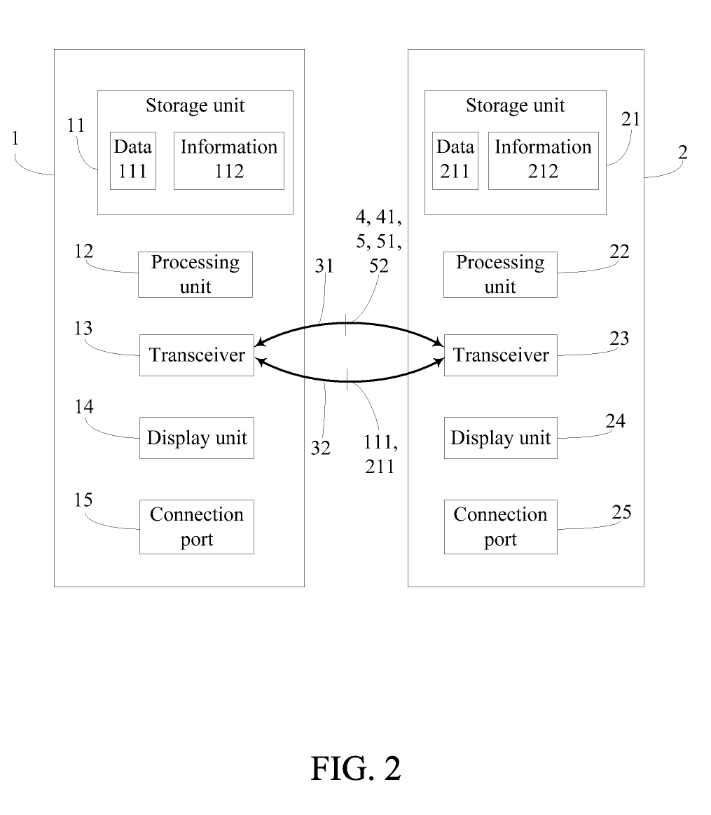

A first embodiment of the present invention is illustrated in FIG. 1, which is a schematic view of two data exchange apparatus 1, 2. Please refer to both FIG. 2A and FIG. 2B for schematic views of the data exchange apparatus 1, 2, respectively. The data exchange apparatus 1 comprises a storage unit 11, a processing unit 12, a transceiver 13, a display unit 14, and a connection port 15, while the data exchange apparatus 2 comprises a storage unit 21, a processing unit 22, a transceiver 23, a display unit 24, and a connection port 25.

In this embodiment, the data exchange apparatus 1, 2 are respectively owned by a first user and a second user. The storage unit 11 is configured to store a data 111 and an information 112 of the first user, while the storage unit 12 is configured to store a data 211 and an information 212 of the second user. The information 112, 212 respectively comprise personal information of the first and second users. For example, the personal information may include age, gender, job, etc. The data 111, 211 respectively comprise contact information of the first and second users. For example, the contact information may include phone number, e-mail address, etc. Both of the data exchange apparatus 1, 2 are able to use a plurality of channels. At the beginning, the processing unit 12 of the data exchange apparatus 1 selects an initial channel (not shown in FIG. 1) among the channels. Thereafter, the transceiver 13 of the data exchange apparatus 1 listens to the initial channel for a predetermined time interval to see if any data exchange request can be received. It is assumed that the processing unit 12 determines that the transceiver 13 receives no data exchange request through the initial channel within the predetermined time interval. Then, the processing unit 12 of the data exchange apparatus 1 selects another channel, say a first channel 31, among the channels. After the first channel 31 is selected by the processing unit 12, the data exchange apparatus 1 listens to the first channel 31.

At some time instant, the processing unit 22 also selects the first channel 31 for communication. In this embodiment, the time period that the data exchange apparatus 1 stays at the first channel and the time period that the data exchange apparatus 2 stays at the first channel overlap. During the time period that both the data exchange apparatuses 1, 2 stay at the first channel, the transceiver 23 of the data exchange apparatus 2 automatically transmits a data exchange request 4 carrying a data exchange criterion 41 through the first channel. The data exchange criterion 41 may be set by the second user (i.e. the owner of the data exchange apparatus 2) in advance. For example, the data exchange criterion 41 may carry information indicating gender being female and age being in the range of twenty to thirty. Since the data exchange apparatuses 1 still stays at the first channel 31, the transceiver 13 of the data exchange apparatuses 1 receives the data exchange request 4 from the data exchange apparatus 2 through the first channel automatically. After receiving the data exchange request 4, the data exchange apparatus 1 in this embodiment determines whether to exchange data with the data exchange apparatus 2 based on two conditions. First, the processing unit 12 of the data exchange apparatus 1 measures a signal strength of the data exchange request 4 and then determines whether the data exchange apparatus 2 is within a communication range of the data exchange apparatus 1 according the signal strength. For example, if the signal strength is greater than a predetermined value, the processing unit 12 determines that the data exchange apparatus 2 is within the communication range. Second, the processing unit 12 of the data exchange apparatus 1 determines whether the information 112 stored in the first storage unit 11 meets the data exchange criterion 41. For example, if the data exchange criterion 41 carries information indicating gender being female and age being in the range of twenty to thirty, the processing unit 12 determines whether the age and gender comprised in the information 112 meets the data exchange criterion 41. In this embodiment, if the processing unit 12 determines that the data exchange apparatus 2 is within the communication range and the information 112 stored in the first storage unit 11 meets the data exchange criterion 41, then the transceiver 13 of the data exchange apparatus 1 transmits an acknowledgment signal 5 to the data exchange apparatus 2 through the first channel. The transceiver 23 of the data exchange apparatus 2 receives the acknowledgement signal 5 through the first channel. It is noted that in other embodiments, the processing unit 12 may skip any or all of the determinations based on the aforementioned two conditions.

In this embodiment, the acknowledgement signal 5 transmitted by the transceiver 13 carries an offset value 51 and a special data encryption (SDE) code 52. It should be noted that the SDE code indicates the encryption method to be used by both the data exchange apparatus 1, 2. For example, the encryption method may be Data Encryption Standard (DES), Advanced Encryption Standard (AES), RSA, or any other encryption methods, as long as the encryption method is agreed by both the data exchange apparatus 1, 2. After the transceiver 13 transmits the acknowledgement signal 5, the processing unit 12 of the data exchange apparatus 1 selects a second channel 32 among the channels for communication according to the offset value carried in the acknowledgement signal 5. For example, the offset value may be the frequency offset between the first channel 31 and the second channel 32. Likewise, after the transceiver 23 receives the acknowledgement signal 5, the processing unit 22 of the data exchange apparatus 2 selects the second channel 32 among the channel according to the offset value. It is noted that in other embodiments, the acknowledge signal 5 may carry an information indicating a specific channel to use instead of carrying an offset value. For that situation, the processing units 12, 22 select the specific channel as the second channel.

The processing unit 12 of the data exchange apparatus 1 and the processing unit 22 of the data exchange apparatus 2 respectively encrypt the data 111 and the data 211 according to an encryption algorithm indicated by the SDE code. Thereafter, the transceiver 13 of the data exchange apparatus 1 transmits the encrypted data 111 to the data exchange apparatus 2 through the second channel 32. The transceiver 23 of the data exchange apparatus 2 receives the encrypted data 111. Similarly, the transceiver 23 of the data exchange apparatus 2 transmits the encrypted data 211 to the data exchange apparatus 1 through the second channel 32. The transceiver 13 of the data exchange apparatus 1 receives the encrypted data 211.

After receiving the encrypted data 211, the processing unit 12 of data exchange apparatus 1 decrypts it according to the encryption algorithm indicated by the SDE code 52, and then stores the decrypted data in the storage unit 11. Similarly, after receiving the encrypted data 111, the data exchange apparatus 2 decrypts according to the encryption algorithm indicated by the SDE code 52, and then stores the decrypted data in the storage unit 21. Afterwards, the display unit 14 of the data exchange apparatus 1 is able to display the second data 211 originally stored in the first storage unit 11. Likewise, the display unit 24 of the data exchange apparatus 2 is able to display the data 111 originally stored in the storage unit 21. It is noted in other embodiments, the acknowledgement signal may not carry an SDE code. For the embodiments that the acknowledgment signal without an SDE code, the processing unit 12, 22 skip the aforementioned encryptions and decryptions.

Furthermore, the data exchange apparatus 1, 2 can be respectively connected with computers 16, 26 through the connection port 15, 25 and respectively transmit the received data 211, 111 to the computers 16, 26. In other embodiments, the connection port can be optional.

According the aforementioned description, the data exchange apparatus 1 acts passively because it receives the data exchange request, while the data exchange apparatus 2 acts actively because it transmits the data request. However, it should be noted that the data exchange apparatus 1 can perform all the functions of the data exchange apparatus 2, and vice versa.

In the present invention, the data exchange apparatus that acts actively transmits a data exchange request automatically, wherein the data exchange request carries a data exchange criterion set by the owner. Therefore, the owner can set the data exchange criterion as he or she likes. On the other hand, the data exchange apparatus that acts passively switches from channel to channel to see if any data exchange request can be received. Once both the data exchange apparatus acting actively and the data exchange apparatus acting passively stay at the same channel, they may be able to exchange data. In addition, the data exchange request and the acknowledgement signal are transmitted and received through one channel, while data are transmitted and received through another channel. By using a different channel for data transmission and receiving, data can be exchanged in a secure fashion.

Consequently, people who owned a data exchange apparatus of the present invention can easily gather information according to his or her requirement from people who also own a data exchange apparatus.

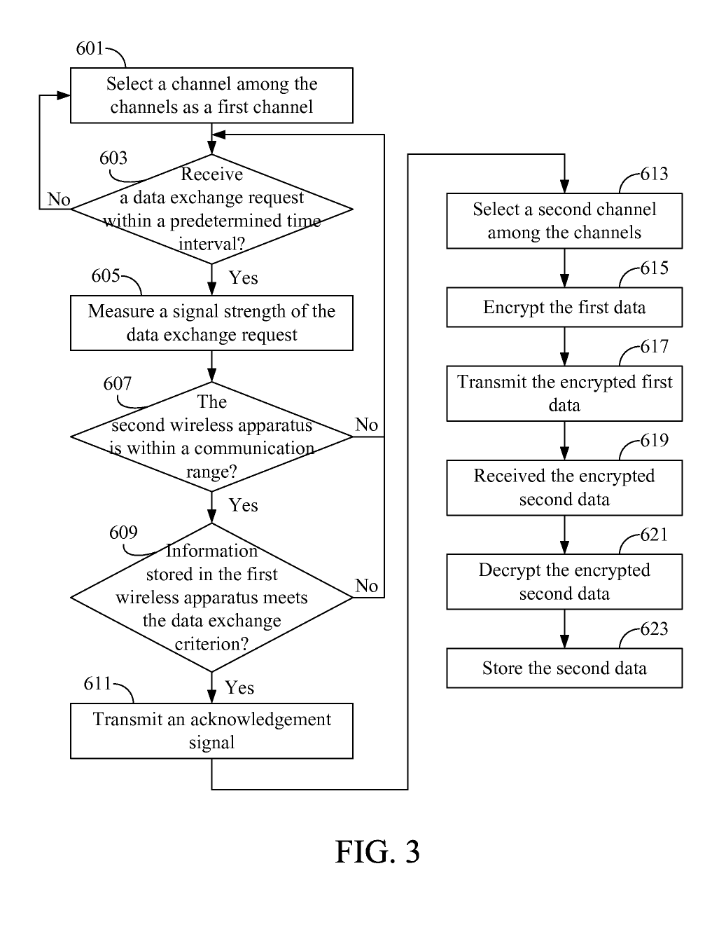

A second embodiment of the present invention is illustrated in FIG. 3, which is a data exchange method for use in a wireless apparatus, such as the data exchange apparatus 1 described in the first embodiment. The wireless apparatus is able to use a plurality of channels to communicate with other wireless apparatuses, such as the data exchange apparatus 2 described in the first embodiment. The wireless apparatus acts passively; that is, the wireless apparatus listens from channel to channel to see if it can receive any data exchange request.

First, the data exchange method executes step 601 to the enable the wireless apparatus select a channel among the channels as a first channel. Next, step 603 is executed to determine whether the wireless apparatus automatically receive a data exchange request from another apparatus through the channel selected in the step 601 within a predetermined time interval. If it is not in the step 603, the data exchange method executes the step 601 again to select another channel among the channels as a first channel.

If it is yes in the step 603 (i.e. the wireless apparatus automatically receive a data exchange request from another wireless apparatus, such as the data exchange apparatus 2 of the first embodiment, through the first channel selected in the step 601), then the data exchange method executes step 605 so that the wireless apparatus measures a signal strength of the data exchange request. In this embodiment, the data exchange request carries a data exchange criterion and an offset value.

Next, step 607 is executed by the wireless apparatus to determine whether the another wireless apparatus is within a communication range according to the signal strength that measured in the step 605. If it is not in the step 607, then the data exchange method executes the step 603 again. If it is yes in the step 607, step 609 is executed to determine whether an information stored in the wireless apparatus meets the data exchange criterion. It is noted that in other embodiments, the steps 605 and 607 may be omitted. If it is not in the step 609, the data exchange method executes the step 603 again. If it is yes in the step 609, the wireless apparatus executes step 611 to transmit an acknowledgment signal to the another wireless apparatus through the first channel selected in the step 601, wherein the acknowledgment signal carries an offset value and a SDE code.

Step 613 is then executed by the wireless apparatus to select a second channel for later communication according to the offset value of the acknowledgment signal. Afterward, step 615 is executed by the wireless apparatus to encrypt a first data stored in the wireless apparatus with the SDE code. Then, step 617 is executed to transmit the encrypted first data to the another wireless apparatus through the second channel selected in the step 613. Next, step 619 is executed to receive an encrypted second data from the another wireless apparatus through the second channel. Subsequently, the wireless apparatus executes step 621 to decrypt the encrypted second data with the SDE code into the second data. Finally, step 623 is executed to store the second data in the wireless apparatus. It is noted that the steps 619 and 621 may be executed before the steps 615 and 617. In other embodiments, if no SDE code is carried in the acknowledgment signal, steps 615 and 621 may be omitted.

In addition to the above steps, the data exchange method is able to execute all the operations and functions as those described for the data exchange apparatus 1 in the first embodiment. Those skilled in the art can directly understand how this embodiment can execute the operations and functions based on the first embodiment. Consequently, redundant descriptions for the operations and functions are not repeated herein.

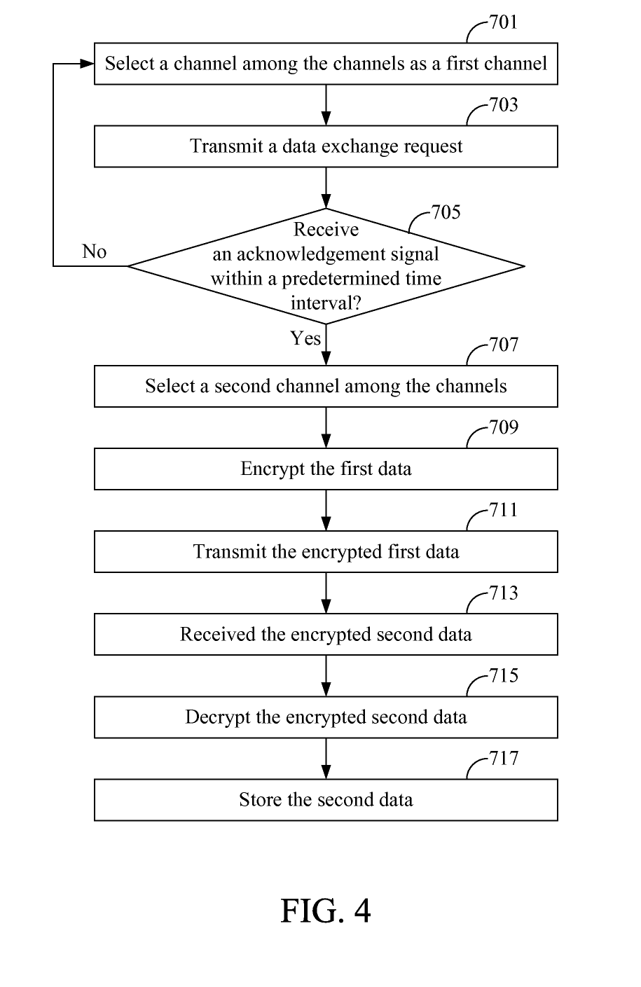

A third embodiment of the present invention is illustrated in FIG. 4, which is a data exchange method for use in a wireless apparatus, such as the data exchange apparatus 2 described in the first embodiment. The wireless apparatus is able to use a plurality of channels to communicate with other wireless apparatuses, such as the data exchange apparatus 1 described in the first embodiment. The wireless apparatus of the third embodiment acts actively; that is, the wireless apparatus transmit a data exchange request indicating the intension to exchange data.

The data exchange method executes step 701 to enable the wireless apparatus select a channel among the channels as a first channel. Then, the wireless apparatus transmits a data exchange request carrying a data exchange criterion in step 703. Next, the wireless apparatuses executes step 705 to determine whether an acknowledgment signal is received through the first channel, wherein the acknowledgment signal may carry an offset value and a SDE code. If it is no, it means that no other wireless apparatus within the communication of the wireless apparatus agrees to exchange data with the wireless apparatus; therefore, the data exchange method executes the step 701 again. If it is yes (i.e. the wireless apparatus receive an acknowledgment signal from another wireless apparatus, such as the data exchange apparatus 1 of the first embodiment), it means that the another wireless apparatus is willing to exchange data with the wireless apparatus so step 707 is then executed.

In step 707, the wireless apparatus selects a second channel according to the acknowledgement. In this embodiment, since the acknowledgement signal carry the offset value, the second channel is selected according to the offset value of the acknowledgment signal. Next, step 709 is executed to by the wireless apparatus to encrypt a first data stored in the wireless apparatus with the SDE code. Then, step 711 is executed by the wireless apparatus to transmit the encrypted first data to the another wireless apparatus through the second channel. In step 713, the wireless apparatus receives an encrypted second data from the another wireless apparatus through the second channel. Subsequently, step 715 is executed by the wireless apparatus to decrypt the encrypted second data as the second data with the SDE code. Finally, the wireless apparatus executes step 717 to store the second data.

It is noted that the steps 713 and 715 may be executed before the steps 709 and 711. In other embodiments, if no SDE code is carried in the acknowledgment signal, steps 709 and 715 may be omitted.

In addition to the above steps, the data exchange method is able to execute all the operations and functions as those described for the data exchange apparatus 2 in the first embodiment. Those skilled in the art can directly understand how this embodiment can execute the operations and functions based on the first embodiment. Consequently, redundant descriptions for the operations and functions are not repeated herein.

According to the aforementioned descriptions, the present invention provides a convenient approach for people to exchange data. A data exchange apparatus (i.e. wireless apparatus being able to execute the data exchange method) is equipped with the active mode and/or passive mode. A user may operate a data exchange apparatus in the active mode by setting a data exchange criterion, then the data exchange apparatus can transmit data exchange request automatically to see if another other data exchange apparatus in the neighborhood storing data that meets the data exchange criterion. On the other hand, the user can operate the data exchange apparatus in the passive mode; that is, the data exchange apparatus functions in response to a data exchange request from other data exchange apparatuses.

Consequently, people who owned a data exchange apparatus of the present invention can easily gather information according to his or her requirement from people who also own a data exchange apparatus.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data exchange method for use in a wireless apparatus, the wireless apparatus being able to use a plurality of channels, the data exchange method comprising the steps of:
(a) selecting a first channel among the channels;
(b) receiving a data exchange request from another wireless apparatus through the first channel automatically;
(c) transmitting an acknowledgment signal to the another wireless apparatus through the first channel after receiving the data exchange request;
(d) selecting a second channel among the channels according to the acknowledgment signal;
(e) transmitting a first data stored in the wireless apparatus to the another wireless apparatus through the second channel; and
(f) receiving a second data from the another wireless apparatus through the second channel.

2. The method as claimed in claim 1, further comprising the following steps before the step (a):
selecting a third channel among the channels; and
determining that no data exchange request is received through the third channel within a predetermined time interval.

3. The method as claimed in claim 1, wherein the data exchange request carries a data exchange criterion and the method further comprises the step of:
(g) determining that an information stored in the wireless apparatus meets the data exchange criterion;
wherein the steps (d), (e), and (f) are executed after the step (g).

4. The method as claimed in claim 1, further comprising the following steps:
(g) measuring a signal strength of the data exchange request;
(h) determining that the another wireless apparatus is within a communication range according to the signal strength,
wherein the step (c) transmits the acknowledgement signal according to the determination of the step (h).

5. The method as claimed in claim 1, wherein the acknowledgment signal carries an offset value and the step (d) selects the second channel according to the offset value.

6. The method as claimed in claim 1, wherein the acknowledgment signal carries a special data encryption (SDE) code and the first data is encrypted with the SDE code.

7. The method as claimed in claim 1, wherein the acknowledgment signal carries an SDE code, the second data is encrypted with the SDE code, and the method further comprises the steps of:
decrypting the second data with the SDE code; and
storing the decrypted second data in a memory.

8. A data exchange method for use in a wireless apparatus, the wireless apparatus being able to use a plurality of channels, the data exchange method comprising the steps of:
(a) selecting a first channel among the channels;
(b) transmitting a data exchange request to another wireless apparatus through the first channel automatically;
(c) receiving an acknowledgement signal from the another wireless apparatus through the first channel after transmitting the data exchange request;
(d) selecting a second channel among the channels according to the acknowledgement signal;
(e) transmitting a first data to the another wireless apparatus through the second channel; and
(f) receiving a second data from the another wireless apparatus through the second channel.

9. The method as claimed in claim 8, wherein the acknowledgement signal carries an offset value and the step (d) selects the second channel according to the offset value.

10. The method as claimed in claim 8, wherein the acknowledgment signal carries an SDE code and the first data is encrypted with the SDE code.

11. The method as claimed in claim 8, wherein the acknowledgement signal carries an SDE code, the second data is encrypted with the SDE code, and the method further comprises the steps of:
decrypting the second data with the SDE code; and
storing the decrypted second data in a memory.

12. A data exchange apparatus, being able to use a plurality of channels, the data exchange apparatus comprising:
a storage unit, being configured to store a first data;
a processing unit, being configured to select a first channel among the channels; and
a transceiver, being configured to receive a data exchange request from another data exchange apparatus through the first channel automatically and transmit an acknowledgment signal to the another data exchange apparatus after receiving the data exchange request;
wherein the processing unit being further configured to select a second channel among the channels according to the acknowledgement signal and the transceiver being further configured to transmit a first data to the another data exchange apparatus through the second channel and receive a second data from the another data exchange apparatus through the second channel.

13. The data exchange apparatus as claimed in claim 12, wherein the processing unit is further configured to select a third channel among the channels and determine that no data change request is received through the third channel within a predetermined time interval, wherein the processing unit selects the first channel after the determination.

14. The data exchange apparatus as claimed in claim 12, wherein the storage unit further stores an information, the data exchange request carries a data exchange criterion, and the processing unit further determines that the information meets the data exchange criterion, wherein after determining the information meeting the data exchange criterion, the processing unit selects the second channel and the transceiver transmits the first data and receives the second data.

15. The data exchange apparatus as claimed in claim 12, wherein the processing unit is further configured to measure a signal strength of the data exchange request and determine that the another data exchange apparatus is within a communication range according to the signal strength, wherein the transceiver transmits the acknowledgement signal according to the determination of the another data exchange apparatus being within the communication range.

16. The data exchange apparatus as claimed in claim 12, wherein the acknowledgment signal carries an offset value and the processing unit selects the second channel according to the offset value.

17. The data exchange apparatus as claimed in claim 12, wherein the acknowledgment signal carries an SDE code and the first data is encrypted with the SDE code.

18. The data exchange apparatus as claimed in claim 12, wherein the acknowledgment signal carries an SDE code and the processing unit is further configured to decrypt the second data with the SDE code and store the decrypted second data in the storage unit.

19. The data exchange apparatus as claimed in claim 18, further comprising a display unit being configured to display the second data.

20. The data exchange apparatus as claimed in claim 12, further comprising a connection port being configured to connect with a computer and transmit the second data to the computer.

21. A data exchange apparatus, being able to use a plurality of channels, the data exchange apparatus comprising:
a storage unit, being configured to store a first data;
a processing unit, being configured to select a first channel among a plurality of channels; and
a transceiver, being configured to transmit a data exchange request to another data exchange apparatus through the first channel automatically and receive an acknowledgement signal from the another data exchange apparatus through the first channel after transmitting the data exchange request,
wherein the processing unit is further configured to select a second channel among the channels according to the acknowledgement signal and the transceiver is further configured to transmit the first data to the another data exchange apparatus through the second channel and receive a second data from the another data exchange apparatus through the second channel.

22. The data exchange apparatus as claimed in claim 21, wherein the acknowledgement signal carries an offset value and the processing unit selects the second channel according to the offset value.

23. The data exchange apparatus as claimed in claim 21, wherein the acknowledgment signal carries an SDE code and the first data is encrypted with the SDE code.

24. The data exchange apparatus as claimed in claim 21, wherein the acknowledgment signal carries an SDE code, the second data is encrypted with the SDE code, and the processing unit is further configured to decrypt the second data with the SDE code and store the decrypted second data in the memory.

25. The data exchange apparatus as claimed in claim 21, further comprising a display unit being configured to display the second data.

26. The data exchange apparatus as claimed in claim 21, further comprising a connection port being configured to connect with a computer and transmit the second data to the computer.
